(19) United States
(12) Patent Application Publication
(10) Pub. No.: US 2018/0041083 A1
(43) Pub. Date: Feb. 8, 2018

(54) STATOR FOR AN ELECTRICAL MACHINE

(71) Applicant: SIEMENS AKTIENGESELLSCHAFT, 80333 München (DE)

(72) Inventors: MATTHIAS CENTNER, Berlin (DE); MARCO FESTA, Falkensee (DE); ELIAS KAUFHOLD, Berlin (DE); ILJA SABELFELD, Berlin (DE)

(73) Assignee: SIEMENS AKTIENGESELLSCHAFT, 80333 München (DE)

(21) Appl. No.: 15/537,148

(22) PCT Filed: Nov. 25, 2015
(86) PCT No.: PCT/EP2015/077618

§ 371 Date: Jun. 16, 2017

(30) Foreign Application Priority Data
Dec. 18, 2014 (EP) 14198843.6

(51) Int. Cl. H02K 3/14; H02K 15/00; H02K 1/16

(52) U.S. Cl. CPC H02K 3/14; H02K 1/16; H02K 15/0081

(57) ABSTRACT

A stator constructed for an electrical machine and operable at an electrical power of at least 1 MW includes a hollow-cylinder-shaped stator yoke defining an axis and having a radially inner side formed with an open groove which extends in an axial direction. Disposed in surrounding relation to the stator yoke is a toroidal coil which includes a groove segment arranged in the open groove, a back segment arranged on a radially outer face of the stator yoke, and axial end faces, with each axial end face having a radial segment to connect the groove segment to the back segment.

The invention relates to a stator for an electrical machine, wherein the stator is able to be operated with an electrical power of at least 1 MW, wherein the stator has a hollow-cylinder-shaped stator yoke and at least one open groove, which is arranged on the radially inner face of the stator yoke and which extends in the axial direction in each case. The invention further relates to an electrical machine having a stator of this type. Finally the invention relates to a mill or a compressor having such an electrical machine.

In rapidly-rotating electrical machines, especially in two-pole machines, the winding heads have a large axial extent. Typically the overall length of both winding heads is of a similar size to the active length, so that only around half the theoretically usable length between the bearing points is magnetically active.

Attempts to push the bearings into the winding head area have to date had little success. In particular the diameter of active magnetic bearings for high-power electrical machines is too large for the bearings to be able to be accommodated within the winding heads. Although the winding heads could theoretically be offset by a greater amount radially outwards, so that the winding head diameter in the area of the bearing will be enlarged, the space requirements are still critical however for electrical and geometrical reasons. In the case of a former-wound coil winding, a coil with a heavily offset winding head area would be even more difficult or not possible at all to wind in through the stator bore.

A division of the laminated stator core would theoretically enable more greatly offset coils to be inserted more easily, since winding in would no longer be necessary, however it is not possible, because of the chording that is usual and necessary for geometrical reasons, to manufacture a self-contained stator half.

With a bar winding strongly offset bars can also be wound through the stator bore. Despite this, the requirements regarding minimum spacings in the winding head do not allow any much greater offsets. In addition the ability to implement a stator with a bar winding depends on the magnetic flux, i.e. the size of the machine and the voltage across the terminals. In a few cases particular versions of bar windings would then have to be used, which are then expensive however and have far more connecting points.

Were arranging the bearings further under the winding heads to succeed, this reserve could either lead to a reduction in the bearing spacing and consequently to improved versions as regards rotor dynamics, or the rated power could be increased with the bearing spacing remaining the same. Even better results could be achieved if the winding heads were able to be axially greatly shortened. While with full pole synchronous machines, e.g. with turbo rotors, the axial length of the rotor cap then becomes the limiting element, with asynchronous machines, because of the comparatively narrow short-circuit rings, much greater potential for better utilization of the overall length between the bearing points can be recognized.

In high-speed machines it will often be taken into account that the rotor speed lies above the first flexural vibration-critical rotational speed. This leads to restrictions in the rotational speed range. In addition the torque able to be achieved is determined for a given bearing spacing. The trend is moving towards higher powers at high speeds, so that alternate solutions are necessary.

With large, high-pole machines, as are used for example as drives in ore mills, the stators do not leave the factory completely assembled, but are delivered in segments with the cross-section of a circular segment and completed to form the stator on site. With chorded two-layer winding, naturally a few coils must be inserted into the laminated stator core at the site where the motor will be used, because forward conductors and return conductors do not lie in the same segment. The completion of the stator winding at the site where the motor will be used represents a large outlay.

A ring motor, which can be used for a mill drive, is known for example from DE 10 2007 005 131 B3.

Were the problem to be solved successfully, complete segments could be delivered, which would merely have to be mechanically combined and electrically connected on site.

With high-pole machines with a segmented construction there are versions with a mandatorily unchorded single-layer winding, wherein the winding head areas of the individual coils differ from one another. Thus a crossing of two, in this case even at least three, coils within the winding head is made possible. The manufacturing outlay, because of the different coil shapes, is all the greater, the greater is the number of grooves per pole and section. However the overall number of the coils only amounts to half the number of coils with two-layer winding.

Using the previously explained stators and electrical machines as its starting point, the object of the invention is to develop a stator or an electrical machine of the type mentioned at the start in such a way that the disadvantages of the prior art described above will be overcome.

One solution to the problem is produced for a stator of the type mentioned at the start by at least one toroidal winding, which surrounds the stator yoke in each case, wherein the at least one toroidal coil has a groove segment in each case, which is arranged in the respective groove, wherein the at least one toroidal coil has a back segment in each case, which is arranged on the radially outer face of the stator yoke, and wherein the at least one toroidal coil has one radial segment per axial end face, which connects the respective groove segment to the respective back segment.

A further solution to the problem is produced by an electrical machine having a stator of this type. Finally a solution to the problem is produced by a mill or a compressor having an electrical machine of this type.

The proposed stator is especially suitable for large electrical machines, since it is able to be operated with an electrical power of at least 1 MW. For example the stator can have an internal diameter of at least 500 mm or at least 1000 mm. The proposed electrical machine has a rotor supported to allow its rotation in the stator for example, is preferably a rotary machine and can be embodied for example as a wind power generator or drive motor, especially a ring motor. In particular when the stator is used in a mill or a compressor the internal stator diameter can however also exceed 3 m or 5 m, wherein the stator is then able to be operated with an electrical power of at least 10 MW, in some cases at least 25 MW. The proposed compressor can be embodied as a piston compressor or as a turbo compressor for example. For example a corresponding ring motor can have an internal stator diameter of around 15 m.

The stator yoke can for example be composed of ring segments of a hollow cylinder, wherein it is also conceivable for the stator yoke to be designed in one piece. Provided in the stator yoke is at least one groove, open radially inwards, which essentially extends in the axial direction.

The proposed stator has at least one toroidal coil, which has a groove segment, a back segment and two radial segments in each case, wherein one radial segment is provided for each axial end face. The respective toroidal coil designed in this way surrounds the stator yoke in this case. For example this can be imagined as two rings interlaced or entwined into one another, wherein one of the rings is the stator yoke and the other of the rings is the at least one toroidal coil. Thus the respective toroidal coil surrounds the hollow-cylinder-shape stator yoke in a plane that will be spanned by the axial direction and a radial direction.

The underlying considerations for the proposed stator are thus as follows:

The winding head does not contribute to torque formation. It is however necessary to connect the forward conductors electrically to the return conductors. If the forward conductor lies under a magnetic north pole, the return conductor for a conventional winding must lie under a magnetic south pole. Otherwise the currents would cancel each other out and the overall torque would—at least theoretically—be zero.

It is possible to entirely dispense with the torque-forming effect of the return conductor. The inactive return conductor must then be routed back in an area of the machine cross-section to the other machine side, where it cannot result in any torque formation. This requirement is fulfilled outside the stator yoke when the stator lies outside and surrounds the rotor.

This will especially be achieved by an arrangement of one coil or of a number of coils, which is or are arranged toroidally around the stator yoke. This basic winding arrangement is known by the term toroidal windings or toroidal coil. It has been investigated for small machines, which are designed either as radial flux machines or as axial flux machines and can produce electrical outputs that are smaller by an order of magnitude than the proposed stator of the proposed electrical machine. Usually with the said small machines, the stator yoke will be directly wound, as is also usual with ring core transformers.

Such small machines are known for example from the following published documents: WO 99/019962 A1, U.S. Pat. No. 4,563,606 A, EP 2 017 945 A1, U.S. Pat. No. 4,103,197 A, EP 1 324 472 A2, WO 02/089291 A2, wherein in said documents in some cases an encapsulation of the stator with epoxy resin is provided.

From the documents relating to the previous prior art the manufacturing and use of toroidal coils in large machines, i.e. in particular for stators or electrical machines with an electrical power of at least 1 MW, is not known.

The simple design of the toroidal coils is advantageous in relation to classical coils previously used for large machines. They will be wound around four posts arranged in a rectangle for example.

The use of toroidal coils is advantageous in particular when the rotor is not to be or cannot be introduced through the stator bore, since this usually demands a division of the yoke into at least two segments. This is therefore based on toroidal coils not usually being able to be inserted into a closed stator yoke. With the high-pole stators described it is the case in any event. With rapidly rotating machines two stator halves must be manufactured, which will then be joined together. This can be of advantage in particular with the turbo compressors mentioned above, if the compressor housing has a horizontal part joint. This is because this enables the actual compressor unit and the drive motor to be combined in the same technology. In particular the stators could likewise be divided into an upper half and a lower half.

A further possibility consists of inserting two insulated toroidal coils, largely independent of one another, into a groove and then laying these two toroidal coils separately from one another on the stator yoke.

Although the proposed toroidal coil gives rise to a number of advantages, a few disadvantages also come to light. For example it is the case with conventional two-pole machines that the inactive conductor length in the winding head is already greater than the active conductor length, so that the ratio of the active conductor length to the overall conductor length amounts to around 1.0:2.2. However the magnetically inactive conductor proportion increases further with toroidal coils. The ratio of the active conductor length to the overall conductor length now lies at around 1.0:2.5 to 1.0:3.0. This results in an increase in current heat losses. An implementation in a specific project thus depends decisively on the weighting of the requirements and the actual proportion of the current heat losses in the overall losses.

A further disadvantage is the enlargement of the outer stator dimensions, which is caused by the return conductor being routed along the radially outer face of the stator yoke. Preferably in the construction of the area around the stator it will be taken into consideration that where possible no highly-permeable closed paths will be created. A stray flux would be formed by these, which in its turn would lead to a heating-up of the constructional components and an increase in the load-dependent additional losses. Further losses can arise with single-layer windings through a larger field harmonic proportion.

In an advantageous embodiment of the invention the at least one toroidal coil is embodied in each case as a former-wound coil.

Former-wound coils will often be used in stator windings of electrical machines, which will be operated with high voltages, such as for example 6 kV or 8 kV, or with especially high electrical powers, such as for example 10 MW or more. This also stems, inter alia, from the fact that former-wound coils exhibit a very good mechanical stability and are especially suitable for being electrically insulated in such a way from one another or from the stator yoke. External protective mica bands and the like can be used for this purpose for example.

Preferably the respective toroidal coil embodied as a former-wound coil possesses a sufficient width to be able to be wound in a first step onto the stator yoke element. In a second step the respective toroidal coil will be moved radially outwards, wherein the forward conductor or the respective groove segment slides into the groove and the distance between the return conductor or back segment and the stator yoke becomes greater.

In an alternate, advantageous embodiment of the invention the respective groove segment and/or the respective back segment is or are embodied as a bar winding.

Through the embodiment of the respective groove segment and/or of the respective back segment as a bar winding it is made possible to introduce the forward or return conductor in particular into a non-segmented stator yoke and connect them electrically and mechanically to one another thereafter.

In a further advantageous embodiment of the invention the respective groove segment or the respective back segment is embodied together with the two respective radial segments as a bar winding in this case, wherein the respective bar winding is embodied in an S shape in the area of the respective radial segment.

For example a respective toroidal coil can thus be obtained in such a way that the respective groove segment is embodied as an essentially straight design of bar winding, wherein the respective back segment is embodied together with the two respective radial segments as a double S-shaped bar winding. The respective bar windings can easily be manufactured in advance and be arranged on or attached to the stator yoke. The bar windings arranged on or attached to the stator yoke will finally be suitably electrically connected to one another, especially by means of a respective connecting element.

Such an embodiment of the respective toroidal coil is advantageous where space is restricted. The reason for this is that the respective bar windings can be embodied such that they essentially rest directly against the stator yoke and thus require little installation space. At the same time these types of bar windings are comparatively resource-preserving and low-loss, since otherwise savings can be made in offsets often required on the winding head.

In a further advantageous embodiment of the invention the respective bar winding is embodied in this case as a Roebel bar.

The embodiment of the respective bar winding as a Roebel bar makes it possible to reduce the losses arising during the operation of the corresponding electrical machine. If both the groove segment and also the back segment of a respective toroidal coil are embodied as a bar winding, there can be provision for only embodying one of the two bar windings as a Roebel bar, in order to make cost savings. The other of the two bar windings can be designed without any subconductor twisting.

In a further advantageous embodiment of the invention the at least one toroidal coil has a winding start arranged on the outside in each case and a winding end arranged on the inside, wherein the respective winding start is arranged on the respective back segment or on one of the respective radial sections, and wherein the respective winding end is arranged on the respective groove segment, on the respective back segment or on one of the respective radial sections.

The winding start or the winding end are intended in this case to be at that end of the winding of the respective toroidal coil, which is arranged in relation to the respective toroidal coil further out or further in than the respective opposite end.

Of advantage compared to classical coils is the comparatively simple design of the toroidal winding. For example it will be wound around posts arranged in a rectangle, as with the former-wound coils explained above for example. This makes possible an extremely flexible embodiment of the forward line or return line of the electrical current to the respective toroidal coil on the basis of the respective winding start or winding end. This flexibility is provided even if the respective toroidal coil is embodied as a bar winding.

For example the respective winding start can be arranged on one of the respective radial sections and the respective winding end on the respective back segment. It is also conceivable for the respective winding start to be arranged on a respective groove segment and for the respective winding end to be arranged on a respective back segment. As an alternative both the respective winding start and the respective winding end can be arranged on the respective back segment, wherein the respective winding start and the respective winding end are each arranged for example in the region of the axial center or at the respective axial end. Further combinations of the arrangement of the respective winding start and the respective winding end are conceivable and can be chosen according to the respective requirements.

In a further advantageous embodiment of the invention the respective radial segment is embodied in a V shape in the axial direction such that the respective groove segment is arranged completely in the respective groove and the respective back segment rests against the radial outer side of the stator yoke in each case.

For example the V-shaped embodiment of the respective radial segment can be achieved by the respective toroidal coil being drawn in the axial direction in the area of the axial center of the respective radial segment. The force applied for deformation or drawing points in this case in the axial direction and away from the stator yoke. In particular a respective toroidal coil with a rectangular cross-section is deformed by this method such that after the drawing it has the cross-section of an elongated hexagon. It is also conceivable that the V of the radial segment arising is embodied instead in a U shape and thus has a type of floor between the two arms, so that the respective toroidal coil is deformed such that, after being drawn, it has the cross-section of an elongated octagon.

Through such an embodiment of the respective toroidal coil in particular the respective return conductor will be pulled as close to the stator yoke as possible, wherein at the same time the respective forward conductor lies optimally in the groove. Thus the respective groove segment lies completely in the respective groove, wherein at the same time the respective back segment rests against the radially outer face of the stator yoke. Overall a compact and space-saving embodiment of the electrical winding of the stator yoke will thus be achieved.

In a further advantageous embodiment of the invention the respective radial segment is embodied in a V shape or Z shape in the circumferential direction such that the respective groove segment in the radial direction is completely arranged in the respective groove and the respective back segment rests against the radially outer face of the stator yoke.

The V-shaped embodiment of the respective radial segment will be achieved in particular by the respective toroidal coil in the area of the axial center of the respective radial segment being drawn in the circumferential direction. In particular with this method a respective toroidal coil with a rectangular cross-section will be deformed such that, after it has been drawn, it has the cross-section of a rectangle when viewed from above, wherein the rectangle is designed kinked along its long side in the center. It is also conceivable that the V of respective radial segment arising is embodied in a U shape instead and thus has a type of floor between the two arms.

As an alternative a Z-shaped embodiment of the radial segment can also be provided. This can be achieved in particular by the respective radial segment being divided into three thirds and by the first and last third being fixed in each case and subsequently turned in relation to one another in the circumferential direction and the respective radial segment thus being deformed. In this way a respective radial segment is obtained, of which the first and last third point in the radial direction and of which the second third connects the two others turned in relation to one another in the circumferential direction.

Through such an embodiment of the respective toroidal coil the respective return conductor will in particular be pulled as close as possible to the stator yoke, wherein at the same time the respective forward connector lies optimally in the groove. Thus the respective groove segment lies completely in the respective groove, wherein at the same time the respective back segment rests against the radial outer segment of the stator yoke. Overall, viewed in an axial direction, a compact and space-saving embodiment of the electrical winding of the stator yoke will be achieved by this.

In a further advantageous embodiment of the invention at least two toroidal coils are arranged in the respective groove.

The at least two toroidal coils can be arranged in this case in the circumferential direction next to one another and/or in the radial direction on one another. Thanks to the proposed toroidal coils, especially viewed in the axial direction, a comparatively space-saving winding head area can be realized, so that comparatively little installation space is necessary for the embodiment of the electrical winding of the stator yoke.

In a further advantageous embodiment of the invention the stator is embodied as a two-pole stator.

Thanks to the proposed toroidal coils, compared to conventional windings of a stator yoke, with a stator embodied as a two-pole stator, an especially large space saving can be achieved, viewed in the axial direction.

The invention will be described and explained in greater detail below on the basis of the exemplary embodiments shown in the figures, in which:

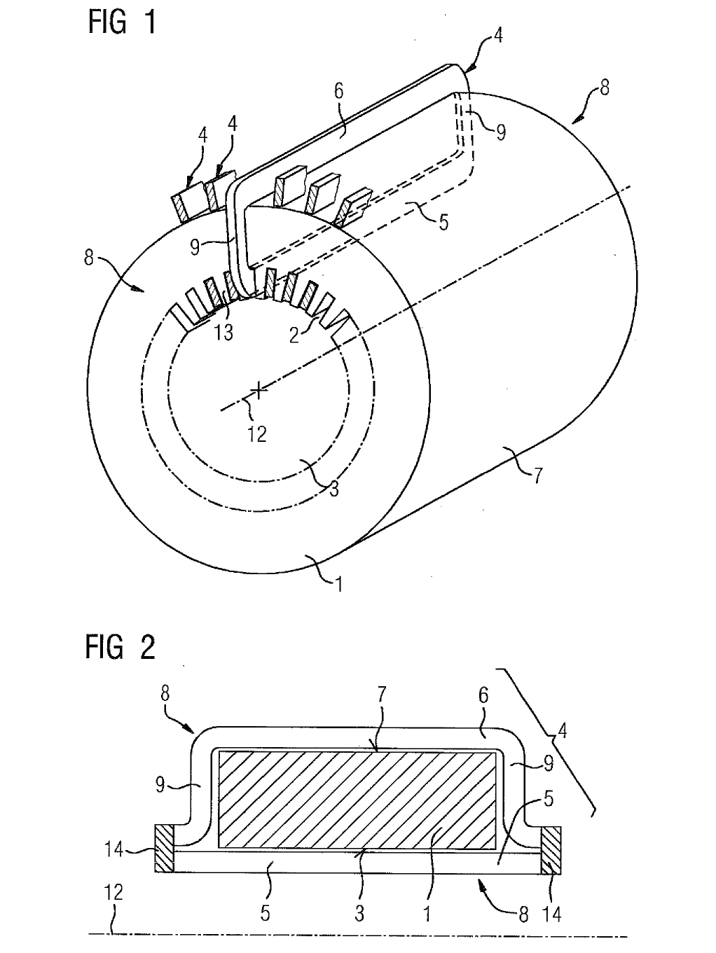

FIG. 1 shows a first exemplary embodiment of the proposed stator,

FIG. 2 shows a segment of a second exemplary embodiment of the proposed stator,

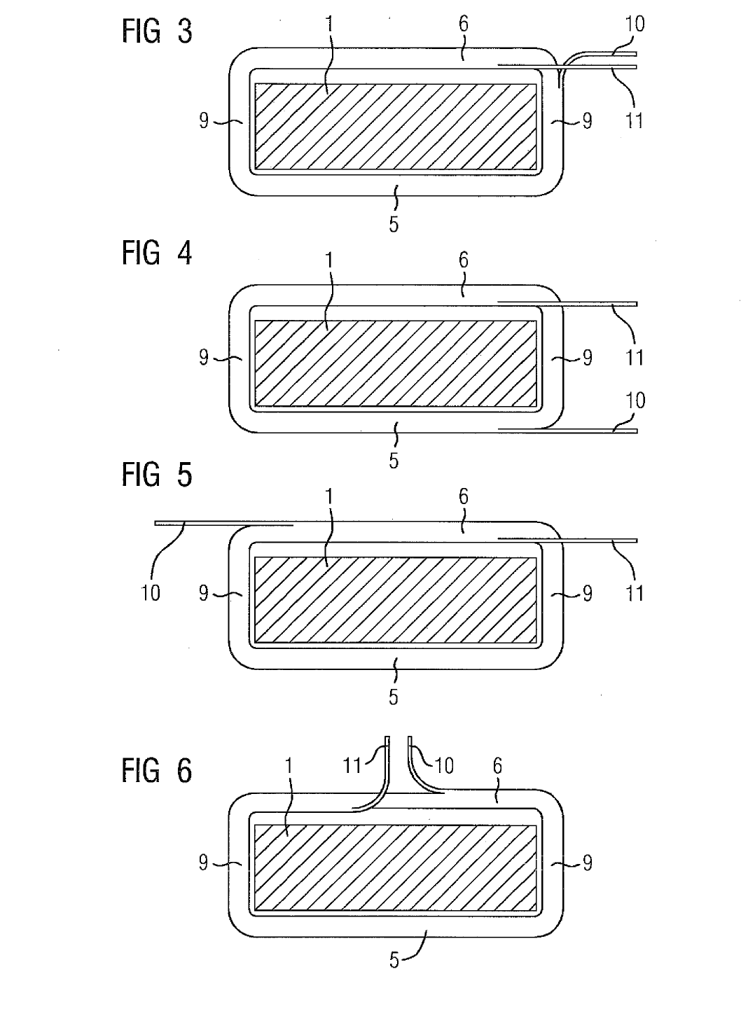

FIGS. 3-6 show a group of third exemplary embodiments of the proposed stator,

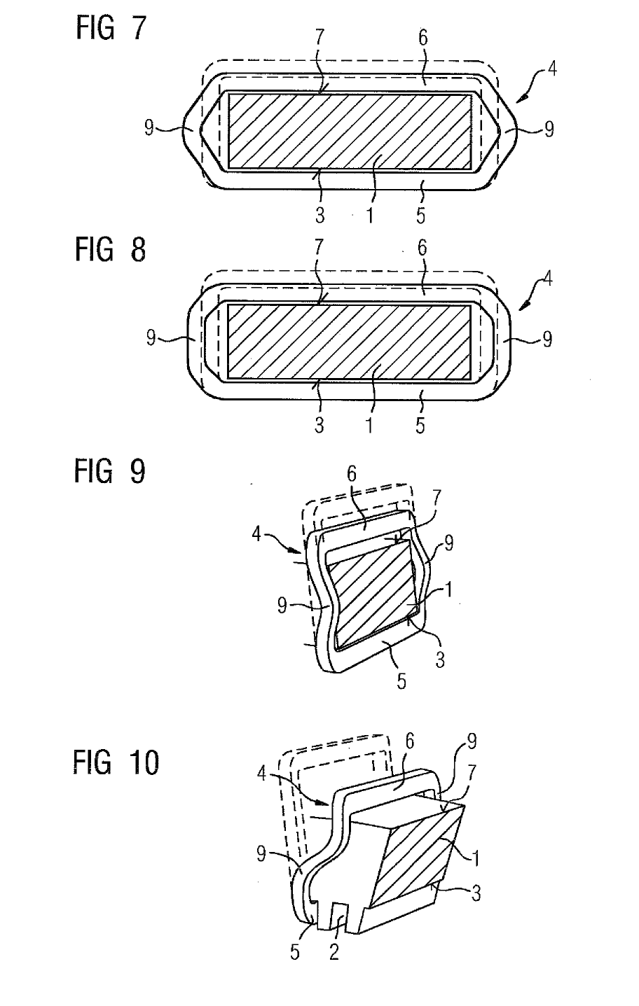

FIGS. 7-8 show a group of fourth exemplary embodiments of the proposed stator,

FIGS. 9-10 show a group of fifth exemplary embodiments of the proposed stator,

FIG. 1 shows a first exemplary embodiment of the proposed stator. The stator has a hollow-cylinder-shaped stator yoke 1 with a stator axis 12 and a number of open grooves 2, which are each arranged on the radial inner side 3 of the stator yoke 1 which each extend in the axial direction. A stator tooth 13 thus remains in each case between two neighboring grooves 2. The stator in this case is designed for operation with an electrical power of at least 1 MW.

Furthermore the stator has a number of toroidal coils 4, which each surround the stator yoke 1. A few of the toroidal coils 4 will merely be indicated in FIG. 1 in this case. The respective toroidal coil 4 has a groove segment 5 in each case, which is arranged in the respective groove 2. The respective toroidal coil 4 also has a back segment 6 in each case, which is arranged on the radially outer face 7 of the stator yoke 1. In addition the respective toroidal coil 4 has a radial segment 9 on each of the two axial end faces 8, which connects the respective groove segment 5 to the respective back segment 6.

The respective toroidal coil 4 can be embodied as a former-wound coil for example. As an alternative the respective groove segment 5 and/or the respective back section 6 can be embodied as a bar winding, which can be embodied for its part as a Roebel bar in each case.

FIG. 2 shows a section of a second exemplary embodiment of the proposed stator, wherein a section along the stator axis 12 is depicted. In this figure the same reference characters as in FIG. 1 refer to the same objects.

The groove segment 5 of the toroidal coil 4 is designed as a bar winding. In addition the back segment 6 and also the two radial segments 9 together are designed as a bar winding, for which purpose the bar winding is embodied in the shape of an S in the area of the respective radial segment 9. The two bars of the toroidal coil 4 are suitably electrically connected to one another at the two axial end faces 8 by means of a respective connection element 14.

Preferably the respective bar winding is embodied as a Roebel bar. In order to make cost savings however, just one of the respective bar windings can also be embodied as a Roebel bar, while the other of the respective bar windings can be designed without subconductor twisting.

FIGS. 3-6 show a group of third exemplary embodiments of the proposed stator, wherein, in a similar manner to FIG. 2, a longitudinal section 12 is depicted. The toroidal coil 4 has a winding start 10 arranged on the outside and a winding end 11 arranged on the inside in each case.

In the embodiment according to FIG. 3 the winding start 10 is arranged on one of the radial segments 9 and the winding end 11 on the back segment 6. By contrast, in the embodiment according to FIG. 4, the winding start 10 is arranged on the groove segment 5 and the winding end 11 on the back segment 6. The embodiments according to FIGS. 5 and 6 make provision for both the winding start 10 and also the winding end 11 to be arranged on the back segment 6. In the embodiment according to FIG. 5 the winding start 10 and the winding end 11 are arranged in this case on the respective axial end, while by contrast, in the embodiment according to FIG. 6, the winding start 10 and the winding end 11 are each arranged in the region of the axial center.

FIGS. 7 and 8 show a group of fourth exemplary embodiments of the proposed stator, wherein, in a similar manner to FIG. 2, a longitudinal segment 12 is depicted.

The design of the toroidal coil 4 is indicated in these figures by the dashed line, before its two radial sections 9 have been embodied in a V shape or a U shape. Before the deformation or drawing the toroidal coil 4 has an essentially rectangular cross-section. Through the deformation or drawing the respective radial segment 9, as shown in FIG. 7 or FIG. 8, will be embodied in a V shape or a U shape in the axial direction, such that the groove segment 5 is arranged in the radial direction completely in the groove 2 and the back segment 6 rests against the radially outer face 7 of the stator yoke 1.

FIGS. 9 and 10 show a group of fifth exemplary embodiments of the proposed stator.

The design of the toroidal coil 4 is indicated in these figures by the dashed line, before its two radial sections 9 have been embodied in a V shape or a Z shape. Before the deformation or drawing the toroidal coil 4 has an essentially rectangular cross-section. By the deformation or drawing the respective radial segment 9, as shown in FIG. 9 or FIG. 10, will be embodied in a V shape or a Z shape in the axial direction such that the groove segment 5 is arranged in the radial direction completely in the groove 2 and the back segment 6 rests against the radially outer face 7 of the stator yoke 1.

In summary the invention relates to a stator for an electrical machine, wherein the stator is able to be operated with an electrical power of at least 1 MW, wherein the stator has a hollow-cylinder-shaped stator yoke and at least one open groove, which is arranged on the radially inner face of the stator yoke and which extends in the axial direction in each case. The invention further relates to an electrical machine having a stator of this type. Finally the invention relates to a mill or a compressor having such an electrical machine. In order to develop such a stator or such an electrical machine in such a way as to overcome the disadvantages of the prior art previously described, at least one toroidal coil is proposed, which surrounds the stator yoke in each case, wherein the at least one toroidal coil has a groove segment in each case, which is arranged in the respective groove, wherein the at least one toroidal coil has a back segment in each case, which is arranged on the radially outer face of the stator yoke, and wherein the at least one toroidal coil has one radial segment per axial end face, which connects the respective groove segment to the respective back segment. Furthermore an electrical machine having such as stator and also a mill or a compressor having such an electrical machine will be proposed.

What is claimed is:

1.-12. (canceled)

13. A stator for an electrical machine, said stator operable with an electrical power of at least 1 MW and comprising:
a hollow-cylinder-shaped stator yoke defining an axis and having a radially inner side formed with an open groove which extends in an axial direction; and
a toroidal coil disposed in surrounding relation to the stator yoke, said toroidal coil including a groove segment arranged in the open groove, a back segment arranged on a radially outer face of the stator yoke, and axial end faces, each said axial end face having a radial segment to connect the groove segment to the back segment.

14. The stator of claim 13, wherein the toroidal coil is configured as a former-wound coil.

15. The stator of claim 13, wherein the groove segment and/or the back segment is configured as a bar winding.

16. The stator of claim 13, wherein the groove segment and/or the back segment, together with the radial segments on the axial end faces, is configured as bar winding, said bar winding having an S shaped configuration in an area of the radial segments.

17. The stator of claim 15, wherein the bar winding is configured as a Roebel bar.

18. The stator of claim 13, wherein the toroidal coil has a winding start arranged on an outside and a winding end arranged on an inside of the toroidal coil, the winding start and the winding end each being arranged on the groove segment, on the back segment or on one of the radial segments.

19. The stator of claim 13, wherein the radial segment is configured in the axial direction in a V shape such that the groove segment is arranged completely in the open groove in a radial direction and the back segment rests against the radially outer face of the stator yoke.

20. The stator of claim 13, wherein the radial segment is configured in a circumferential direction in a V shape or a Z shape such that the groove segment is arranged completely in the open groove in a radial direction and the back segment rests against the radially outer face of the stator yoke.

21. The stator of claim 13, wherein at least two of said toroidal coil are arranged in the open groove.

22. The stator of claim 13, constructed in the form of a two-pole stator.

23. An electrical machine, comprising a stator operable with an electrical power of at least 1 MW, said stator including a hollow-cylinder-shaped stator yoke defining an axis and having a radially inner side formed with an open groove which extends in an axial direction, and a toroidal coil disposed in surrounding relation to the stator yoke, said toroidal coil including a groove segment arranged in the open groove, a back segment arranged on a radially outer face of the stator yoke, and axial end faces, each said axial end face having a radial segment to connect the groove segment to the back segment.

24. The electric machine of claim 23, wherein the toroidal coil is configured as a former-wound coil.

25. The electric machine of claim 23, wherein the groove segment and/or the back segment is configured as a bar winding.

26. The electric machine of claim 23, wherein the groove segment and/or the back segment, together with the radial segments on the axial end faces, is configured as bar winding, said bar winding having an S shaped configuration in an area of the radial segments.

27. The electric machine of claim 25, wherein the bar winding is configured as a Roebel bar.

28. The electric machine of claim 23, wherein the toroidal coil has a winding start arranged on an outside and a winding end arranged on an inside of the toroidal coil, the winding start and the winding end each being arranged on the groove segment, on the back segment or on one of the radial segments.

29. The electric machine of claim 23, wherein the radial segment is configured in the axial direction in a V shape such that the groove segment is arranged completely in the open groove in a radial direction and the back segment rests against the radially outer face of the stator yoke.

30. The electric machine of claim 23, wherein the radial segment is configured in a circumferential direction in a V shape or a Z shape such that the groove segment is arranged completely in the open groove in a radial direction and the back segment rests against the radially outer face of the stator yoke.

31. The electric machine of claim 23, wherein at least two of said toroidal coil are arranged in the open groove.

32. The electric machine of claim 23, wherein the stator is constructed in the form of a two-pole stator.

33. A mill or a compressor, comprising an electrical machine, said electric machine comprising a stator operable with an electrical power of at least 1 MW, said stator including a hollow-cylinder-shaped stator yoke defining an axis and having a radially inner side formed with an open groove which extends in an axial direction, and a toroidal coil disposed in surrounding relation to the stator yoke, said toroidal coil including a groove segment arranged in the open groove, a back segment arranged on a radially outer face of the stator yoke, and axial end faces, each said axial end face having a radial segment to connect the groove segment to the back segment.
